(19) United States
(12) Patent Application Publication
(10) Pub. No.: US 2018/0236953 A1
(43) Pub. Date: Aug. 23, 2018

(54) VEHICLE-MOUNTED CONNECTOR PAIR

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventor: Yuji Nakura, Yokkaichi, Mie (JP)

(21) Appl. No.: 15/752,032

(22) PCT Filed: Jul. 29, 2016
(86) PCT No.: PCT/JP2016/072294

§ 371 Date: Feb. 12, 2018

(30) Foreign Application Priority Data
Aug. 19, 2015 (JP) 2015-161602

(51) Int. Cl. B60R 16/023; H01R 13/66; H04L 12/28; H01R 31/08; H04L 12/66

(52) U.S. Cl. CPC B60R 16/023; H01R 13/66; H04L 12/66; H01R 31/08; H04L 12/28

(57) ABSTRACT

Unauthorized access of signals is restricted without significantly complicating the structure of a vehicle-mounted connector. A communication circuit-side connector is mounted on a communication circuit. The communication circuit-side connector includes a signal transmission pin that is used to transmit a signal, a pair of power supply pins that are used to supply power, and short circuit pins that are short-circuited to each other by a short circuit line. The short circuit pins function as a power supply path due to the power supply pin and the short circuit pins being short-circuited by the short circuit pin and the short circuit line of the signal processing circuit-side connector.

This application is the U.S. national stage of PCT/JP2016/072294 filed Jul. 29, 2016, which claims priority of Japanese Patent Application No. JP 2015-161602 filed Aug. 19, 2015.

### TECHNICAL FIELD

The present invention relates to a vehicle-mounted connector pair. The vehicle-mounted connector pair contributes to a configuration for electrically connecting a vehicle-mounted LAN (Local Area Network), a vehicle-mounted ECU (Electronic Control Unit), and a vehicle-mounted GW (Gate Way) to each other, for example.

### BACKGROUND

JP 2006-164706A discloses that:

(i) a wire harness terminal and a vehicle-mounted ECU are connected by fitting together a connector of the vehicle-mounted wire harness terminal and a connector of the vehicle-mounted ECU,
(ii) when the above-described two connectors enter a separated state from the fit-together state, it is determined as an abnormality, and
(iii) a relay circuit in the wire harness terminal-side connector blocks a communication path when the abnormality is determined.

Employing the above-described technique is desirable from the viewpoint of preventing unauthorized access to the wire harness terminal, and by extension, unauthorized access to the vehicle-mounted LAN.

Note that JP 2013-172200A introduces a relay apparatus that functions as a vehicle-mounted GW.

However, in the above-described technique, a separation determination unit for determining the abnormality, a relay circuit, and a control circuit for blocking the relay circuit have been needed. When the separation determination unit, the relay circuit, and the control circuit are provided inside of the connector, the structure of the connector becomes complicated. This complication makes it difficult to ensure reliability of the connector and increases the cost needed for the manufacture of the connector.

In view of this, the present invention aims to restrict unauthorized access to signals transmitted in the connector without significantly complicating the structure of the vehicle-mounted connector.

### SUMMARY

A connector pair includes a first connector that is connected to a vehicle-mounted communication circuit, and a second connector that is connected to a vehicle-mounted signal processing circuit. Signals are transmitted between the communication circuit and the signal processing circuit due to the first connector and the second connector being connected.

The first connector includes a signal transmission pin that is used to transmit the signal, a pair of power supply pins that are used to supply power to the signal processing circuit due to the connection between the first connector and the second connector, and multiple short circuit pins that are short-circuited to each other.

The second connector includes a pair of power receiving pins that are connected to a pair of power source lines that are used to supply power to the signal processing circuit, a signal transmission pin that is used to transmit the signal between the communication circuit and the signal processing circuit, and multiple short circuit pins that are short-circuited to each other. The vehicle-mounted connector pair are in a relationship in which, due to the first connector and the second connector being connected, electrical conduction is established between the signal transmission pin of the first connector and the signal transmission pin of the second connector, electrical conduction is established between one of the pair of power supply pins and one of the pair of power receiving pins via the plurality of short circuit pins of the second connector and the plurality of short circuit pins of the first connector, and electrical conduction is established between the other of the pair of power receiving pins and the other of the pair of power supply pins.

### Advantageous Effects of Invention

With this kind of connector pair, unauthorized access to the signals is restricted without significantly complicating the structures of both the first connector and the second connector.

### BRIEF DESCRIPTION OF DRAWINGS

FIG. 1 is a diagram illustrating an example of a vehicle-mounted connector pair according to a first embodiment.

FIG. 2 is a diagram showing a function of an adapter for unauthorized access.

FIG. 3 is a diagram showing a connected state of an adapter for unauthorized access.

FIG. 4 is a diagram illustrating an example of a vehicle-mounted connector pair according to a first variation of the first embodiment.

FIG. 5 is a diagram partially illustrating an example of a vehicle-mounted connector pair according to a second variation of the first embodiment.

FIG. 6 is a diagram illustrating an example of a vehicle-mounted connector pair according to a second embodiment.

### DETAILED DESCRIPTION OF PREFERRED EMBODIMENTS

### First Embodiment

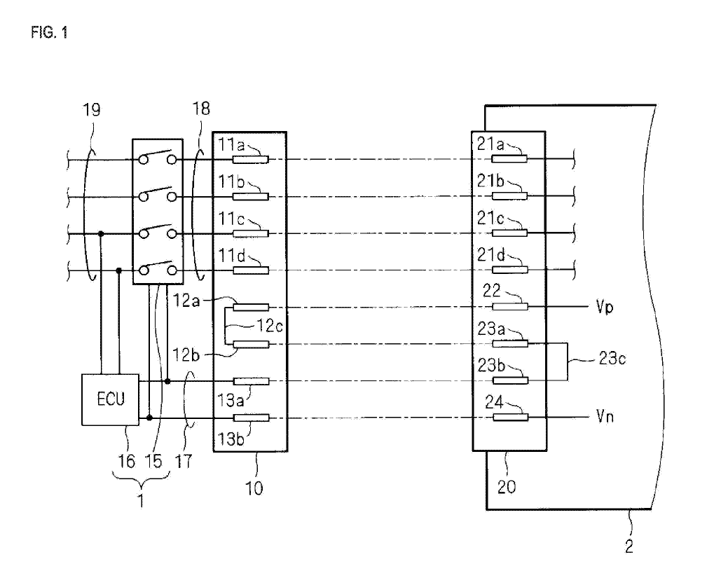

A vehicle-mounted connector pair according to a first embodiment will be described hereinafter. FIG. 1 is a schematic view illustrating an example of a vehicle-mounted connector pair. The vehicle-mounted connector pair includes a vehicle-mounted communication circuit-side connector 20 and a vehicle-mounted signal processing circuit-side connector 10.

The communication circuit-side connector 20 is connected to a vehicle-mounted communication circuit 2. The communication circuit 2 is a vehicle-mounted GW serving as a vehicle-mounted relay apparatus, for example. For example, the communication circuit-side connector 20 is mounted on the communication circuit 2. The signal processing circuit-side connector 10 is connected to a vehicle-mounted signal processing circuit 1. Due to the communication circuit-side connector 20 and the signal processing circuit-side connector 10 being connected, signals are transmitted between the signal processing circuit 1 and the communication circuit 2. Also, later-described power supply from the communication circuit 2 to the signal processing circuit 1 is realized.

The signal processing circuit-side connector 10 is connected to relays 15 and an ECU 16. The relays 15 and the ECU 16 operate by receiving a supply of power via the signal processing circuit-side connector 10. Due to this operation, the ECU 16 generates signals that are transmitted between the signal processing circuit 1 and the communication circuit 2. Due to the operation, the relays 15 relay the signals to predetermined pins of the signal processing circuit-side connector 10. Accordingly, the relays 15 and the ECU 16 together can be understood as the signal processing circuit 1 that operates due to receiving power via the signal processing circuit-side connector 10. Also, the signal processing circuit-side connector 10 can be understood as being connected to the signal processing circuit 1.

The communication circuit-side connector 20 includes signal transmission pins 21a, 21b, 21c, and 21d, a pair of power supply pins 22 and 24, and multiple short circuit pins 23a and 23b. The signal transmission pins 21a, 21b, 21c, and 21d are used to transmit the above-described signals. The power supply pins 22 and 24 output voltages that are used to supply power to the signal processing circuit 1. Here, a case is illustrated in which the power supply pins 22 and 24 output potentials Vp and Vn respectively (Vp≠Vn).

Normally, an operation power source that is needed for the operation of the communication circuit 2 is supplied from an external apparatus to the communication circuit 2. Thus, the technique of applying the potentials Vp and Vn respectively to the power supply pins 22 and 24 based on the operation power source of the communication circuit 2 is a technique that is obvious to a person skilled in the art, and will not be described in detail here.

The short circuit pins 23a and 23b are short-circuited to each other inside of the communication circuit-side connector 20 or in the communication circuit 2. Here, a case is illustrated in which the short circuit pins 23a and 23b are short-circuited to each other by the short circuit line 23c inside of the communication circuit-side connector 20.

The signal processing circuit-side connector 10 includes the signal transmission pins 11a, 11b, 11c, and 11d, a pair of power receiving pins 13a and 13b, and multiple short circuit pins 12a and 12b. The signal transmission pins 11a, 11b, 11c, and 11d transmit signals to the relays 15 (or in a broader sense, to the signal processing circuit 1).

Specifically, a wiring group 18 is connected between the signal transmission pins 11a, 11b, 11c, and 11d, and one side of the relays 15 (the right side in the drawing). On the other hand, a wiring group 19 (e.g., a wire harness to be used in a vehicle-mounted LAN) is connected to the other side (the left side in the drawing) of the relays 15. The ECU 16 and another signal generation unit (not shown) are connected to the wiring group 19.

Accordingly, the above-described signals are transmitted between the wiring group 19 and the signal transmission pins 11a, 11b, 11c, and 11d due to the operation of the relays 15, and the transmission is not performed if the relays 15 do not operate. This is desirable from the viewpoint that even if it is known that the signal transmission pins 11a, 11b, 11c, and 11d are signal transmission pins, unauthorized access to the signals transmitted to the wiring group 19 via the image processor circuit-side connector 10 is restricted if the relays 15 do not operate. Of course, if power is not supplied to the ECU 16, the ECU 16 does not operate, and the signals generated during the operation of the ECU 16 cannot be accessed without authorization.

The short circuit pins 12a and 12b are short-circuited to each other inside or outside of the signal processing circuit-side connector 10. Here, a case is illustrated in which the short circuit pins 12a and 12b are short-circuited to each other by a short circuit line 12c inside of the signal processing circuit-side connector 10. The power receiving pins 13a and 13b are connected to a pair of power source lines 17. The operation power sources of the relays 15 and the ECU 16 are supplied thereto via the power source lines 17.

The following relationship is satisfied due to the connection between the signal processing circuit-side connector 10 and the communication circuit-side connector 20: electrical conduction is established between the signal transmission pins 11a, 11b, 11c, and 11d of the signal processing circuit-side connector 10 and the signal transmission pins 21a, 21b, 21c, and 21d of the communication circuit-side connector 20; the power supply pin 22 establishes electrical conduction with the power receiving pin 13a via the short circuit pins 12a and 12b of the signal processing circuit-side connector 10 and the short circuit pins 23a and 23b of the communication circuit-side connector 20; and electrical conduction is established between the power receiving pin 13b and the power supply pin 24.

Due to this conduction relationship, the power source lines 17 receive the potentials Vp and Vn respectively from the power receiving pins 13a and 13b. In other words, it can be said that the power source lines 17 are used to supply power to the signal processing circuit 1. The signal transmission pins 11a, 11b, 11c, 11d, 21a, 21b, 21c, and 21d are used to transmit the signals.

For example, in FIG. 1, a case is illustrated in which the signal transmission pins 11a, 11b, 11c, and 11d, the short circuit pins 12a and 12b, and the power receiving pins 13a and 13b are arranged in the signal processing circuit-side connector 10 in the stated order heading downward from the top of the page, and the signal transmission pins 21a, 21b, 21c, and 21d, the power supply pin 22, the short circuit pins 23a and 23b, and the power supply pin 24 are arranged in the communication circuit-side connector 20 in the stated order heading downward from the top of the page.

Also, the following contact relationship is illustrated: the signal transmission pins 11a, 11b, 11c, and 11d and the signal transmission pins 21a, 21b, 21c, and 21d are in contact with each other, the short circuit pin 12a and the power supply pin 22 are in contact with each other, the short circuit pin 12b and the short circuit pin 23a are in contact with each other, the power receiving pin 13a and the short circuit pin 23b are in contact with each other, and the power receiving pin 13b and the power supply pin 24 are in contact with each other. In FIG. 1, these contact relationships are denoted by one-dot chain lines.

As described above, in the case where the positional relationship between the pair of power receiving pins 13a and 13b and the short circuit pins 12a and 12b of the signal processing circuit-side connector 10 and the positional relationship between the pair of power supply pins 22 and 24 and the short circuit pins 23a and 23b of the communication circuit-side connector 20 match, power is supplied to the signal processing circuit 1 from the communication circuit-side connector 20, the signal processing circuit 1 operates, and signals are correctly transmitted between the signal processing circuit-side connector 10 and the communication circuit-side connector 20.

In other words, in order to access the signals being carried by the wiring group 19 via the signal processing circuit-side connector 10, a communication circuit-side connector 20 that matches the signal processing circuit-side connector 10 is needed. This can also be thought of in the following manner, from the viewpoint of supplying electricity from the communication circuit-side connector 20 to the signal processing circuit 1.

The short circuit pin 23b can be made to function as a power supply path by short-circuiting the short circuit pin 23a and the power supply pin 22 (in the example shown in FIG. 1, they are short-circuited using the short circuit pins 12a and 12b, which are short-circuited by the short circuit line 12c) outside of the communication circuit 2, which is thought to include the communication circuit-side connector 20. Accordingly, a substantial power supply path from the communication circuit-side connector 20 to the signal processing circuit 1 is changed according to the short-circuiting from outside of the communication circuit-side connector 20. This contributes to restricting unauthorized access to the signal transmitted between the signal processing circuit 1 and the communication circuit 2 by an adapter 9 for unauthorized access.

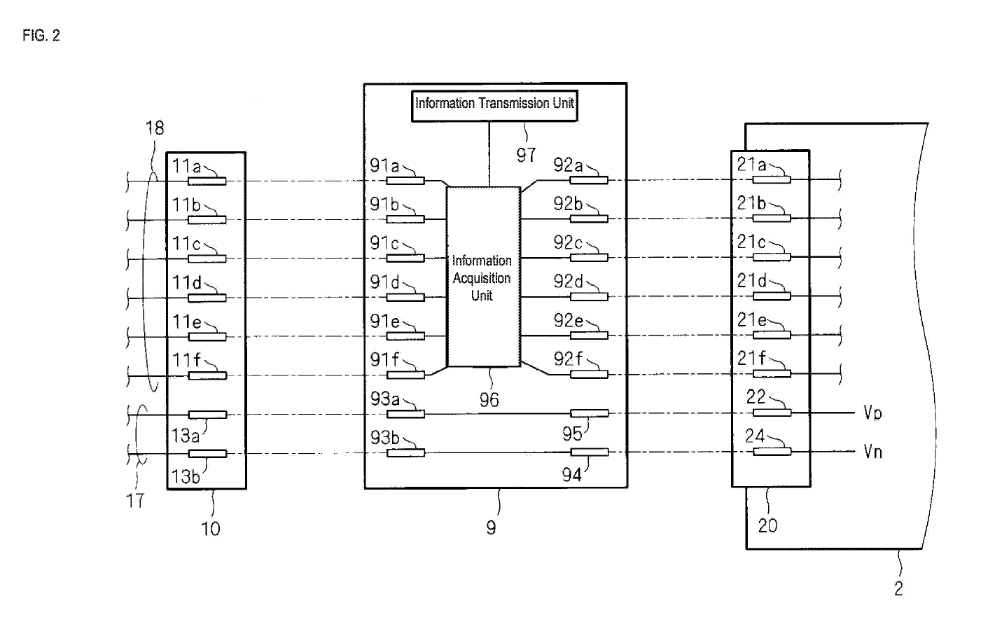

FIG. 2 is a schematic diagram for illustrating a function of the adapter 9 for unauthorized access to the signals. The adapter 9 is connected by being interposed between the signal processing circuit-side connector 10 and the communication circuit-side connector 20, and has a function of extracting the signals being transmitted between the two.

Here, a case will be illustrated in which the signal processing circuit-side connector 10 and the communication circuit-side connector 20 do not include the short circuit pins. Specifically, the signal transmission pins 11a, 11b, 11c, 11d, 11e, and 11f, and the power receiving pins 13a and 13b are arranged in the signal processing circuit-side connector 10 in the stated order heading downward from the top of the page, and the signal transmission pins 21a, 21b, 21c, 21d, 21e, and 21f, and the power receiving pins 22 and 24 are arranged in the communication circuit-side connector 20 in the stated order heading downward from the top of the page. In a mode in which the short circuit pins are not included, if the signal processing circuit-side connector 10 and the communication circuit-side connector 20 are connected, the power supply pins 22 and 24 and the power receiving pins 13a and 13b come into contact and electrical conduction is established therebetween.

If at least the arrangement positions of the power reception pins 13a and 13b in the pin arrangement of this signal processing circuit-side connector 10 or the arrangement positions of the power supply pins 22 and 24 in the pin arrangement of the communication circuit-side connector 20 are known, power distribution pins 93a, 93b, 94, and 95 are provided in the adapter 9. The positions of the power distribution pins 93a, 93b, 94, and 95 are such that contact is made in the following relationships in the case where the adapter 9 is connected by being interposed between the signal processing circuit-side connector 10 and the communication circuit-side connector 20: The power distribution pin 93a and the power receiving pin 13a come into contact; the power distribution pin 93b and the power receiving pin 13b come into contact; the power distribution pin 95 and the power supply pin 22 come into contact; and the power distribution pin 94 and the power supply pin 24 come into contact.

Inside of the adapter 9, the power distribution pins 93a and 95 are connected, and the power distribution pins 93b and 94 are connected and are insulated from the power distribution pins 93a and 95. Thus, the adapter 9 realizes power supply from the communication circuit-side connector 20 to the signal processing circuit 1 via the signal processing circuit-side connector 10. Accordingly, even if the adapter 9 is connected between the signal processing circuit-side connector 10 and the communication circuit-side connector 20, the signal processing circuit 1 operates, and the signals are transmitted to the power transmission pins 11a, 11b, 11c, 11d, 11e, and 11f.

The adapter 9 includes signal interception pins 91a, 91b, 91c, 91d, 91e, and 91f. By connecting the adapter 9 to the signal processing circuit-side connector 10, the signal interception pins 91a, 91b, 91c, 91d, 91e, and 91f come into contact with the signal transmission pins 11a, 11b, 11c, 11d, 11e, and 11f respectively, and electrical connection is established therebetween.

The adapter 9 also includes an information acquisition unit 96, which acquires the signals received by the signal interception pins 91a to 91f. The adapter 9 also includes an information transmission unit 97, which transmits the signals acquired by the information acquisition unit 96 to the outside of the adapter 9. Accordingly, the adapter 9 leaks the information existing in the signals from the signal processing circuit 1.

Note that the adapter 9 also includes signal interception pins 92a, 92b, 92c, 92d, 92e, and 92f. By connecting the adapter 9 to the communication circuit-side connector 20, the signal interception pins 92a, 92b, 92c, 92d, 92e, and 92f come into contact with the signal transmission pins 21a, 21b, 21c, 21d, 21e, and 21f respectively, and electrical conduction is established therebetween. For example, the information acquisition unit 96 has a data buffer, and can intercept the signal between the signal interception pins 91a and 92a while buffering and transmitting it. The same applies to the signals between the signal interception pins 91b to 91f and 92b to 92f.

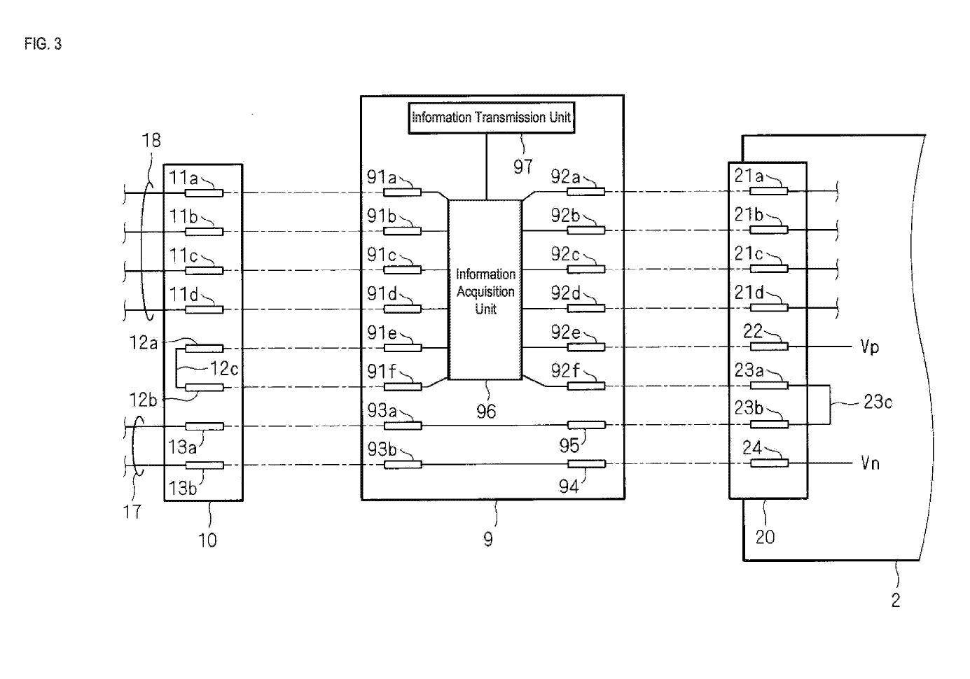

FIG. 3 is a schematic diagram showing a state in which the adapter 9 shown in FIG. 2 is connected by being interposed between the signal processing circuit-side connector 10 and the communication circuit-side connector 20 in the case of employing the vehicle-mounted connector pair shown in FIG. 1.

The signal interception pins 91e and 91f of the adapter 9 come into contact with the short circuit pins 12a and 12b respectively, and the signal interception pins 92e and 92f come into contact with the power supply pin 22 and the short circuit pin 23a respectively. Thus, the information acquisition unit 96 is interposed between the power supply pin 22 and the short circuit pin 23b, and the power supply path is blocked. Accordingly, power supply to the signal processing circuit 1 via the signal processing circuit-side connector 10 is not realized. In this case, the signal processing circuit 1 does not operate. Accordingly, unauthorized access to the signals by the adapter 9 is restricted without significantly complicating the structure of either connector in the vehicle-mounted connector pair.

Alternatively, it is also conceivable to perform unauthorized access to the signals transmitted to the wiring group 18 via the signal processing circuit-side connector 10 by causing the signal processing circuit 1 to operate by supplying power to the signal processing circuit-side connector 10 without using the adapter 9 (so-called “tapping”).

However, even if the position of the pin to be connected to the power supply pin 22 among the pins of the signal processing circuit-side connector 10 is known, it is not easy to supply power to the signal processing circuit 1. This is because the pin to be connected is actually the short circuit pin 12a, and therefore even if power is supplied thereto, the short circuit pin 12b and the power receiving pin 13a cannot be connected, and a power supply path is not established. Moreover, the existence of the short circuit pin 12b functions also as a dummy for the power receiving pins 13a and 13b. Accordingly, supplying power to the signal processing circuit 1 through tapping is not easy. In this manner, unauthorized access to the signals through tapping is also restricted without significantly complicating the structure of either connector in the vehicle-mounted connector pair.

In FIG. 1, a configuration in which the power receiving pin 13b and the power supply pin 24 come into contact with each other was illustrated as a contact relationship for realizing a relationship in which electrical conduction is established between the power receiving pin 13b and the power supply pin 24. However, of course, similarly to the electrical conduction relationship between the power receiving pin 13a and the power supply pin 22, multiple short circuit pins may be provided on both the signal processing circuit-side connector 10 and the transmission circuit-side connector 20, and electrical conduction may be established between the power receiving pin 13b and the power supply pin 24 via these short circuit pins. This is because the contact relationships for realizing electrical conduction contribute to the realization of the power supply path. This viewpoint will be described in detail hereinafter.

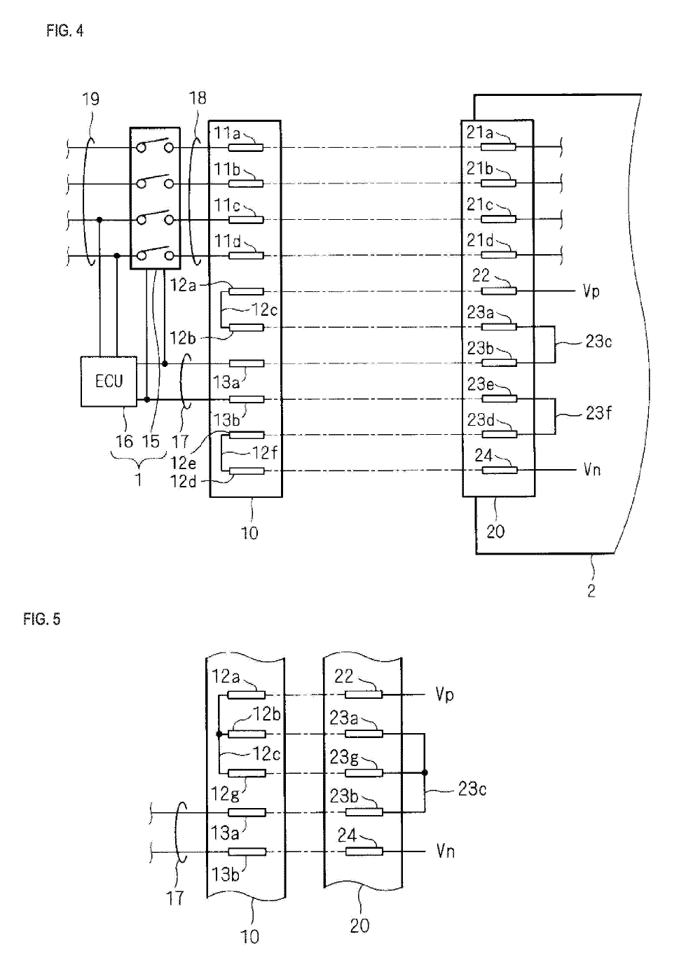

FIG. 4 is a schematic view illustrating a vehicle-mounted connector pair according to a first variation of the first embodiment. In contrast to the configuration shown in FIG. 1, the configuration shown in FIG. 4 is realized as a configuration in which multiple short circuit pins 12d and 12e and a short circuit line 12f for short-circuiting the short circuit pins 12d and 12e are added to the signal processing circuit-side connector 10, multiple short circuit pins 23d and 23e of the communication circuit-side connector 20 are added, and a short circuit line 23f for short-circuiting the short circuit pins 23d and 23e is added to the communication circuit 2.

In FIG. 4, a case is illustrated in which the signal transmission pins 11a, 11b, 11c, and 11d, the short circuit pins 12a and 12b, the power receiving pins 13a and 13b, and the short circuit pins 12e and 12d are arranged in the signal processing circuit-side connector 10 in the stated order heading downward from the top of the page, and the signal transmission pins 21a, 21b, 21c, and 21d, the power supply pin 22, the short circuit pins 23a and 23b, the short circuit pins 23e and 23d, and the power supply pin 24 are arranged in the communication circuit-side connector 20 in the stated order heading downward from the top of the page.

Also, the following contact relationship achieved through connection is illustrated: the signal transmission pins 11a, 11b, 11c, and 11d and the signal transmission pins 21a, 21b, 21c, and 21d are in contact with each other, the short circuit pin 12a and the power supply pin 22 are in contact with each other, the short circuit pin 12b and the short circuit pin 23a are in contact with each other, the power receiving pin 13a and the short circuit pin 23b are in contact with each other, the power receiving pin 13b and the short circuit pin 23e are in contact with each other, the short circuit pin 23d and the short circuit pin 12e are in contact with each other, and the short circuit pin 12d and the power supply pin 24 are in contact with each other. In FIG. 4 as well, this contact relationship is denoted by a one-dot chain line, similarly to FIG. 1.

As described above, the positional relationship between the pair of power receiving pins 13a and 13b and the short circuit pins 12a, 12b, 12d, and 12e of the signal processing circuit-side connector 10 and the pair of power supply pins 22 and 24 and the short circuit pins 23a, 23b, 23d, and 23e is needed so that the signals are correctly transmitted.

Also, the configuration shown in FIG. 4 has a higher degree of freedom in setting the power supply path than the configuration shown in FIG. 1 does. This is desirable from the viewpoint of improving the effect of restricting unauthorized access to the signals.

FIG. 5 is a schematic view partially illustrating a vehicle-mounted connector pair according to a second variation of the first embodiment. In contrast to the configuration shown in FIG. 1, the second variation is realized by an additional pin 12g being added between the short circuit pin 12b and the power receiving pin 13a and a short circuit line 12c short-circuiting the additional pin 12g to the short circuit pins 12a and 12b in the signal processing circuit-side connector 10. Also, in contrast to the configuration shown in FIG. 1, the second variation is realized by an additional pin 23g being added between the short circuit pins 23a and 23b and a short circuit line 23c short-circuiting the additional pin 23g to the short circuit pins 23a and 23b in the communication circuit-side connector 20.

In the second variation, due to the additional pins 12g and 23g being provided, the degree of freedom in the arrangement of the various pins increases and the effect of restricting unauthorized access to the signals improves.

Note that in the second variation as well, the power supply path from the power supply pin 22 to the power receiving pin 13a is obtained through the short circuit pins 12a, 12b, 23a, and 23b. Accordingly, the additional pin 12g may be in a floating state without being short-circuited with the short circuit pins 12a and 12b. Also, the additional pin 23g may be in a floating state without being short-circuited with the short circuit pins 23a and 23b. In FIG. 5, the contact relationship in which the additional pins 12g and 23g are in contact with each other is denoted by a one-dot chain line, but the additional pins 12g and 23g need not be in contact with each other.

### Second Embodiment

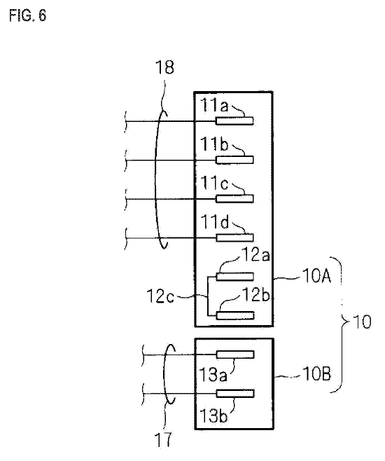

A vehicle-mounted connector pair according to a second embodiment will be described hereinafter. FIG. 6 is a schematic view partially illustrating a vehicle-mounted connector pair according to the second embodiment. Note that in the description of the second embodiment, constituent elements that are the same as those described in the first embodiment are denoted by the same reference numerals thereas, and description thereof is omitted.

In the vehicle-mounted connector pair according to the second embodiment, the signal processing circuit-side connector 10 shown in the first embodiment is realized by being divided into two blocks 10A and 10B.

The block 10A is provided with at least the signal transmission pins 11a, 11b, 11c, and 11d. The block 10B is provided with at least the power receiving pins 13a and 13b.

The short circuit pins 12a and 12b may be mounted on either the block 10A or the block 10B. FIG. 6 illustrates a case in which the short circuit pins 12a and 12b are mounted on the block 10A.

In the case where the signal processing circuit-side connector 10 is thus divided into the two blocks 10A and 10B as well, the function of restricting unauthorized access described in the first embodiment is maintained, as long as the arrangement sequence of the various pins in the signal processing circuit-side connector 10 does not change.

On the other hand, the alignment sequence of the two blocks 10A and 10B can be switched. Accordingly, the function of restricting unauthorized access improves due to the signal processing circuit-side connector 10 being divided into the two blocks 10A and 10B.

Of course, the signal processing circuit-side connector 10 may be divided into three or more blocks. For example, in FIG. 6, the short circuit pins 12a and 12b mounted on the block 10A may be mounted on a third block provided separately from the block 10A.

The embodiments and the configurations described in the modified examples can be combined as appropriate as long as they do not contradict each other.

Although the invention has been described in detail above, the above description is in all aspects exemplary and the invention is not limited thereto. It is understood that infinite variations that have not been illustrated can be envisioned without departing from the scope of the invention.

1. (canceled)

2. A vehicle-mounted connector pair comprising a first connector to be connected to a vehicle-mounted communication circuit and a second connector to be connected to a vehicle-mounted signal processing circuit, a signal being transmitted between the communication circuit and the signal processing circuit due to the first connector and the second connector being connected, wherein
the first connector includes:
a signal transmission pin that is used to transmit the signal;
a pair of power supply pins that are used to supply power to the signal processing circuit through the connection between the first connector and the second connector; and
a plurality of short circuit pins that are short-circuited to each other, and
the second connector includes:
a pair of power receiving pins that are connected to a pair of power source lines that are used to supply power to the signal processing circuit,
a signal transmission pin that is used to transmit the signal between the communication circuit and the signal processing circuit, and
a plurality of short circuit pins that are short-circuited to each other, and
the vehicle-mounted connector pair are in a relationship in which, due to the first connector and the second connector being connected,
electrical conduction is established between the signal transmission pin of the first connector and the signal transmission pin of the second connector,
electrical conduction is established between one of the pair of power supply pins and one of the pair of power receiving pins via the plurality of short circuit pins of the second connector and the plurality of short circuit pins of the first connector, and
electrical conduction is established between the other of the pair of power receiving pins and the other of the pair of power supply pins.

3. The vehicle-mounted connector pair according to claim 2, wherein
the signal processing circuit-side connector includes
an ECU configured to generate the signal by operating due to the supply of power.

4. The vehicle-mounted connector pair according to claim wherein
the signal processing circuit-side connector includes
a relay configured to relay the signal to the signal transmission pin of the second connector by operating due to the power supply.

5. The vehicle-mounted connector pair according to claim 2, wherein
the second connector further includes:
a block provided with at least the signal transmission pin of the second connector; and
another block provided with at least the pair of power receiving pins.

6. The vehicle-mounted connector pair according to claim 3, wherein the signal processing circuit-side connector includes a relay configured to relay the signal to the signal transmission pin of the second connector by operating due to the power supply.

7. The vehicle-mounted connector pair according to claim 3, wherein the second connector further includes:
a block provided with at least the signal transmission pin of the second connector; and
another block provided with at least the pair of power receiving pins.

8. The vehicle-mounted connector pair according to claim 4, wherein the second connector further includes:
a block provided with at least the signal transmission pin of the second connector; and
another block provided with at least the pair of power receiving pins.
